(19) United States
(12) Patent Application Publication
(10) Pub. No.: US 2005/0228699 A1
(43) Pub. Date: Oct. 13, 2005

(54) Cost projections for diagnoses

(75) Inventors: Heidi J. Samuels, Apple Valley, MN (US); Ted A. Lyle, St. Paul, MN (US)

Correspondence Address: FULBRIGHT & JAWORSKI L.L.P., 600 CONGRESS AVE., SUITE 2400, AUSTIN, TX, 78701, US

(73) Assignee: United Health Group Incorporated

(21) Appl. No.: 10/967,629

(22) Filed: Oct. 18, 2004

Related U.S. Application Data
(60) Provisional application No. 60/512,456, filed on Oct. 17, 2003.

(51) Int. Cl. G06F 17/60

(52) U.S. Cl. 705/4

(57) ABSTRACT

Techniques for projecting costs for diagnoses. Past claims data and a set of different multiplying factors are used to arrive at a more accurate cost projection. Example multipliers include a claim lag factor, a trend adjustment, a prescription cost factor, and a disenrollee factor.

This application claims priority to U.S. Provisional Patent Application Ser. No. 60/512,456, which was filed Oct. 17, 2003. U.S. Provisional Patent Application Ser. No. 60/512,456 is incorporated herein by reference in its entirety.

### BACKGROUND OF THE INVENTION

1. Field of the Invention

The present invention generally relates to health care services. More particularly, the invention relates to techniques for projecting costs for a primary disease or diagnosis and especially high cost diagnoses.

2. Background

The accurate projection of costs is important in the arena of health care services. Especially important is the accurate projection of costs (e.g., claims to be paid on behalf of a claimant by a health care company or insurance company) for diagnoses and particularly high cost diagnoses. Traditional techniques do not provide a particular protocol that can be followed easily, step by step, to generate an accurate projection of costs. Further, traditional techniques do not necessarily make full use of past claims data to assist in projecting costs. Moreover, traditional techniques do not utilize multiplying factors for claim lag, trend adjustment, and impact of disenrollees in combination with past claims data to arrive at accurate cost projections.

Thus, a significant need exists for the techniques described and claimed in this disclosure. In particular, what is needed is an improved model for projecting costs and particularly high cost diagnoses. Such a model would allow users to reliably predict costs in a wide range of situations, utilizing the most pertinent past claims data more completely and efficiently.

### SUMMARY OF THE INVENTION

Particular shortcomings of the prior art are reduced or eliminated by the techniques discussed in this disclosure.

As used herein, “a” and “an” shall be interpreted as meaning “one or more.”

In one embodiment, the invention involves a method for projecting costs associated with a diagnosis. An average claim amount paid that is associated with the diagnosis is identified using past claims data. A trend adjustment is applied to the average claim amount paid to yield an adjusted average claim amount paid. Remaining costs are identified by subtracting a value from the adjusted average claim amount paid. A prescription cost factor and disenrollee factor are applied to the remaining costs to yield a cost projection associated with the diagnosis.

The value being subtracted from the adjusted average claim amount paid may include claims that have already been paid. The average claim amount paid may be an average claim amount paid for all causes. The average claim amount paid may be an average claim amount paid for only the diagnosis. The average claim amount paid may be adjusted through the elimination of past claims data associated with claimants whose total incurred claims associated with a diagnosis are less than a particular value. That particular value may be the claims that have already been paid. That particular value could also be the claims that have already been paid adjusted by a claim lag factor. The diagnosis may include, but is not necessarily limited to, any one of the following: Asthma; chronic obstructive pulmonary disease (COPD); Hemophilia; Premature Infants 500-749 Gr; Transplants; Cardiomyopathy; HIV/AIDS; Premature Infants 750-999 Gr; Ulcerative Colitis; Cerebral Vascular Accident; Intervertebral Disc Disease; Premature Infants 1-1.25 KG; Average High Cost Case; Complications of Diabetes; Leukemia; Premature Infants 1.25-1.5 KG; Complications of Surgery; Liver Failure; Premature Infants 1.5-1.75 KG; Congenital Anomalies; Lymphoma; Premature Infants 1.75-2.0 KG; Congestive Heart Failure; Major Trauma; Premature Infants 2-2.5 KG; Coronary Artery Bypass; Malignant Neoplasms; Premature Infants>2.5 KG; Coronary Artery Disease; Morbid Obesity; Premature Infant Weight not otherwise specified (NOS); Electrolyte Disorders; Myocardial Infarction; Respiratory Failure; End Stage Renal Disease; Osteoarthritis; Sepsis; General Digestive Disorders; Premature Infants<500 Gr; or Threatened/Premature Labor. The prescription cost factor and disenrollee factor may constitute a single factor to reflect prescription cost, disenrollees or another consideration.

In one embodiment, the invention involves a method for projecting costs associated with a diagnosis, where claims that have already been paid are identified. A claim lag factor is applied to the claims that have already been paid to yield an adjusted paid claim value. An average claim amount paid that is associated with the diagnosis is identified using past claims data. The average claim amount paid is adjusted through the elimination of past claims data associated with claimants whose total incurred claims associated with the diagnosis are less than the adjusted paid claim value. A trend adjustment is applied to the average claim amount paid to yield an adjusted average claim amount paid. Remaining costs are identified by subtracting the claims that have already been paid from the adjusted average claim amount paid. A prescription cost factor and disenrollee factor are applied to the remaining costs to yield a cost projection associated with the diagnosis.

The diagnosis can include any one of those listed above, and the prescription cost factor and disenrollee factor may constitute a single factor to reflect prescription cost, disenrollees or another consideration.

In one embodiment, the invention involves a computer readable media executable by a computer (e.g., software), and the media includes instructions for: (a) identifying an average claim amount paid that is associated with a diagnosis using past claims data; (b) applying a trend adjustment to the average claim amount paid to yield an adjusted average claim amount paid; (c) identifying remaining costs by subtracting a value from the adjusted average claim amount paid; and (d) applying a prescription cost factor and disenrollee factor to the remaining costs to yield a cost projection associated with the diagnosis.

The media may include spreadsheet instructions. The media may also include instructions for: (a) identifying claims that have already been paid; (b) applying a claim lag factor to the claims that have already been paid to yield an adjusted paid claim value; and (c) adjusting the average claim amount paid, prior to applying the trend adjustment, through the elimination of past claims data associated with claimants whose total incurred claims associated with the diagnosis are less than the adjusted paid claim value. The value subtracted from the adjusted average claim amount paid is the claim amount that has already been paid.

The prescription cost factor and disenrollee factor can constitute a single factor to reflect prescription cost, disenrollees or another consideration.

Other features and associated advantages will become apparent with reference to the following detailed description of specific embodiments in connection with the accompanying drawings.

### BRIEF DESCRIPTION OF THE DRAWINGS

The techniques of this disclosure may be better understood by reference to the following drawings in combination with the detailed description of illustrative embodiments presented here.

FIG. 1 is a schematic diagram displaying representative embodiments for generating cost projections and particularly cost projections for high cost diagnoses using past claims data.

FIG. 2 is a schematic diagram illustrating that embodiments may be utilized by a computer or other computing device.

### Description of Illustrative Embodiments

Techniques of this disclosure aim to address or eliminate shortcomings in the prior art by providing an easy to use cost projection system that better utilizes past claims data while, at the same time, accounts for certain cost-affecting multipliers typically overlooked by conventional methods. These techniques can be used in a vast array of applications and especially in the health care industry to project, e.g., claims for diagnoses and particularly high cost diseases.

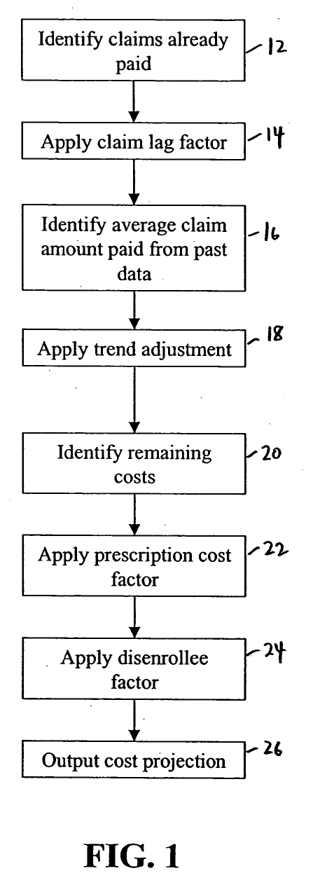

FIG. 1 is a general diagram displaying how a cost projection may be generated for a particular diagnosis, according to embodiments of this disclosure. In the most general sense, the method of FIG. 1 projects costs by assuming that the costs will be similar to the average claim amount paid by other claimants having the same diagnosis. However, the projection is modified from that most general case by applying one or more multiplying factors to values and by carefully calculating the average costs from past claims data so that the average better reflects an accurate projection.

In step 12, one identifies claims that have already been paid for the diagnosis whose costs are being projected. These claims can be subtracted out from a cost projection to reflect the fact that some of the projection has already been actually paid.

In step 14, a multiplier—a claim lag factor, which is greater than 1—may be applied to the claim amount that has already been paid. This claim lag factor accounts for added costs associated with claim lags (or other extra costs associated with claims already paid) and may be expressed as a percentage over the claim amount that has already been paid. This claim lag factor may be set by the practitioner based on experience (e.g., based on past data or estimate). In different embodiments, it may take values of 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, etc. (or any fraction in between these or other values). In a preferred embodiment, the claim lag factor reflects a value 5% over the claim amount already paid. Thus, the factor applied is 1.05—i.e., the value of step 12 is multiplied by 1.05. This value from step 14 or the value from step 12 may be subtracted from the average costs paid by other claimants (multiplied by a factor) to arrive at a projected remaining cost value (which may then be multiplied by two more factors to arrive at a final cost projection).

In step 16, one identifies an average claim amount paid by other claimants having the same diagnosis, using past claims data.

In one embodiment, the average paid claim amount reflects the average claim amount incurred during the last 12 months and paid by 15 months for a number of claimants having the diagnosis that is being projected. Of course, it will be recognized that the time frame may be different depending on how far ahead the user wants to project costs.

In one embodiment, the average paid claim amount takes into account total claims paid not only for the particular diagnosis (e.g., the “primary” disease), but for all causes by claimants having that disease. In other words, if a cost projection is being calculated for primary disease X, then the average paid claim amount may take into account the total claims paid for a first claimant incurring costs for X and Y; a second claimant incurring costs for X, Y, and Z; a third claimant incurring costs for X, A, and B, etc. Note that each of these claimants shares primary disease X, but they are incurring costs for other causes (e.g., diseases, ailments, or other cost-generating conditions) as well. The inventors have discovered that a better cost projection may be arrived-at by realizing that the cost projection for a particular primary disease should take into account that a claimant having that disease will probably be incurring costs for other causes as well. Some diseases may, in fact, be associated with high costs stemming from different albeit related causes. To take into account all causes, one can compile past claims data and calculate the average paid claim amount as follows: divide (a) the total claim amount paid for all causes for claimants having the diagnosis being projected by (b) the number of those claimants.

In another embodiment, average paid claim amount need not take into account the claim amount paid for all causes. Instead, it can use only the total claim amount paid that is directly attributable to the primary disease (instead of all causes). For instance, one may compile past claims data and calculate the average paid claim amount as follows: divide (a) the total claim amount paid for only the primary disease for claimants having the disease being projected by (b) the number of those claimants.

Past claims data may be categorized to show the number of claimants, the total claim amount paid for the primary disease, and the total claim amount paid for all causes (one of the causes of course being the primary disease). Again, in an embodiment where all causes are taken into account, the average claim amount paid is the total paid for all causes divided by the number of claimants. And, in an embodiment where just the primary disease is taken into account, the average claim amount paid is the total paid for the primary disease divided by the number of claimants.

If the past claims data is categorized as described above, one may readily calculate the percentage of the total claim amount paid that is attributable to the primary disease. For instance, if the total claim amount paid for a primary disease for several claimants is $1000, and the total claim amount paid for all causes for those claimants is $2000, then the percentage of the “all causes” total that is attributable to the primary disease is 50%.

In one embodiment, calculating the average claim amount paid may be modified so that data from claimants whose total past claim paid amount is smaller than the claim amount already paid (see step 12 of FIG. 1) is not included in the averaging calculation. Put more simply, if claims already paid are $200, one can ignore (for purposes of calculating the average claim amount paid) past data about a claimant whose total claim amount paid was $50. By doing this, the average claim amount paid is made more accurate because it utilizes data from claimants who, in the past, have incurred costs at least as high as the amount already paid. In a preferred embodiment, what is ignored is data from claimants whose total past claim paid amount is smaller than the claim amount already paid multiplied by the claim lag factor.

In one embodiment, eliminating data in this manner may be made easier by categorizing past claims data in a histogram. For example, data for each primary disease can be broken-out into different “bins” according to the total amount paid for all causes. For example, one bin may include data from claimants whose total claim amount paid was between $1 and $49. another bin may include data from claimants whose total claim amount paid was between $50 and $99, etc. In this embodiment, if the claims already paid were $65 (or claims already paid multiplied by the claim lag factor were $65), one could ignore all the past claims data falling within the first bin because it represents claimants whose total claim amount paid is already lower than that actually paid, or actually paid multiplied by the claim lag factor, for the case being projected.

In step 18, another multiplier—a trend adjustment factor, which is typically greater than 1 but can be less than 1—may be applied to the average claim amount found in step 16. This trend adjustment factor can account for a trend of rising or falling costs with respect to the past claims data. For instance, if costs are rising (e.g., inflation) each year by 2%, a trend adjustment factor can be 1.02. In different embodiments having a positive trend adjustment factor (a factor greater than 1), the factor may take values of 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, etc. (or any fraction in between these or other values). In a preferred embodiment, the trend adjustment factor reflects an upward trend of 12%. Thus, the trend adjustment factor is 1.12. In step 18 in that case, the value from step 16 is multiplied by 1.12.

In different embodiments have a negative trend adjustment factor (a factor less than 1), the factor may take values of 0.50, 0.51, 0.52, 0.53, 0.54, 0.55, 0.56, 0.57, 0.59, 0.60, 0.61, 0.62, 0.63, 0.64, 0.65, 0.66, 0.67, 0.68, 0.69, 0.70, 0.71, 0.72, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, etc. (or any fraction in between these or other values less than 1).

In step 20, projected remaining costs are calculated. In one embodiment, this is done by subtracting the claims already paid (step 12 of FIG. 1) from the value calculated in step 18 (the average claim amount paid multiplied by the trend adjustment factor).

In step 22, another multiplier—a prescription cost factor, which is greater than 1—can be applied to the projected remaining costs calculated in step 20. This factor may account for additional prescription costs for a diagnosis. This factor can be set by the practitioner based on experience (e.g., based on past data or estimate). In different embodiments, it may take values of 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, etc. (or any fraction in between these or other values). In a preferred embodiment, the prescription cost factor reflects a value 19% over the projected remaining costs. Thus, the factor is 1.19. In step 22 in that case, the value from step 20 is multiplied by 1.19.

In step 24, another multiplier—a disenrollee cost factor, which is greater than 1—may be applied to the value calculated in step 22. This factor may account for additional costs attributable to disenrollees to a health program. After a client disenrolls from a health program, certain costs may no longer appear in the former health program's database or records but those costs may nevertheless exist and may be accounted-for using the disenrollee factor. This factor may be set by the practitioner based on experience (e.g., based on past data or estimate). In different embodiments, it may take values of 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, etc. (or any fraction in between these or other values). In a preferred embodiment, this factor reflects a value 10% over the projected remaining costs adjusted by the prescription cost factor. Thus, the factor is 1.10. In step 24 in that case, the value from step 22 is multiplied by 1.10.

In one embodiment, the prescription cost factor and disenrollee factor may constitute a single factor to reflect prescription cost, disenrollees or another consideration. For example, the factors illustrated at steps 22 and 24 of FIG. 1 may make up one factor that can be applied in one step. Having the benefit of the present disclosure, those having ordinary skill in the art will recognize that the application of factors and the mathematical steps of this disclosure may be modified, combined, or otherwise modified to yield the same or similar results.

In step 26, one outputs the final cost projection, which in the illustrated embodiment is the value from step 24. The output can be of any form (digital, paper, etc.) known in the art.

With the benefit of this disclosure, those having ordinary skill in the art will recognize that one or more steps of FIG. 1 can be rearranged, combined, or removed and still achieve improved cost projections. For example, in one embodiment, a user may not wish to apply a claim lag factor but would apply one or more of the other multiplying factors. In such an embodiment, claims already paid can be used without any adjustment. In another embodiment, a trend adjustment may be skipped while applying one ore more of the other multiplying factors. In another embodiment, as mentioned earlier, a prescription cost factor and disenrollee factor can constitute a single multiplying factor to reflect prescription cost, disenrollees or another consideration. Alternatively, neither of these factors may be used, while retaining use of one or more of the other multiplying factors. In sum, the use of factors can vary while still remaining within the scope and spirit of this invention and while still providing improved cost projections.

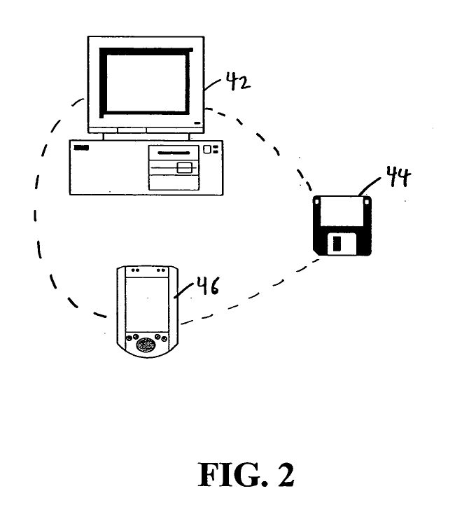

FIG. 2 is included to illustrate that any and all of the techniques of this disclosure can be performed with the assistance of a computer 42 and any associated storage media 44 (removable or not). It can be programmed into appropriate software, firmware, hardware, or any other medium as known in the art. Computer 42 is meant to be a general representation of a computing device and take the form of, for example, a personal computer or any other computing device such as, but not limited to, a personal digital assistant such as PDA 46. The dashed lines of FIG. 2 show that the techniques of this disclosure can be shared or networked among one or more computing devices and results and/or instructions can be transmitted as known in the art. For example, techniques of this disclosure can be accomplished remotely over an appropriate network such as the Internet.

The following examples are included to demonstrate specific, non-limiting embodiments of this disclosure. It should be appreciated by those of skill in the art that the techniques disclosed in the examples that follow represent techniques that function well in the practice of the invention and thus can be considered to constitute specific modes for its practice. However, those of ordinary skill in the art should, in light of the present disclosure, appreciate that many changes can be made in the specific embodiments that are disclosed and still obtain a like or similar result without departing from the spirit and scope of the invention.

### EXAMPLE 1

Embodiments of the present invention can be implemented using spreadsheets. Embodiments can also be implemented using any techniques known in the art such as computer programs written in one or more various languages for a variety of hardware devices. Tabs A-F of U.S. Provisional Patent Application Ser. No. 60/512,456, which have been incorporated by reference, show an example implementation through spreadsheets. A description of such an implementation follows.

A spreadsheet allows a user to select a diagnosis from a list or to select an average high cost diagnosis. The diagnoses from the list include: Asthma, COPD, Cardiomyopathy, Cerebral Vascular Accident, Complications of Diabetes, Complications of Surgery, Congenital Anomalies, Congestive Heart Failure, Coronary Artery Bypass, Coronary Artery Disease, Electrolyte Disorders, End Stage Renal Disease, General Digestive Disorders, Hemophilia, HIV/AIDS, Intervertebral Disc Disease, Leukemia, Liver Failure, Lymphoma, Major Trauma, Malignant Neoplasms, Morbid Obesity, Myocardial Infarction, Osteoarthritis, Premature Infants<500 Gr, Premature Infants 500-749 Gr, Premature Infants 750-999 Gr, Premature Infants 1-1.25 Kg, Premature Infants 1.25-1.5 Kg, Premature Infants 1.75-2 Kg, Premature Infants 2-2.5 Kg, Premature Infants>2.5 Kg, Premature Infant Weight NOS, Respiratory Failure, Sepsis, and Threatened/Premature Labor.

Into the spreadsheet, a user enters the claims paid amount for a current quarter. Other time periods can of course be used, and this step could be done automatically by calling an appropriate on-board or separate database or storage. The claims amount is then multiplied by a factor representing claims lag (in this example, a factor of 1.05 is used to reflect a 5% claims lag percentage).

To identify an average claim amount paid from past data, a second spreadsheet (or separate “sheet” of the same spreadsheet file) is called. That spreadsheet includes historical information about claim amounts associated with several diagnoses, including the diagnosis initially selected by the user. In this example, it includes columns corresponding to: Primary Disease, Size of Payment All Causes, Claimant Count, Total Paid for Primary Disease, Average Paid for Primary Disease, Total Paid for All Causes, Average Paid for All Causes, and Primary Disease % of Total (Average). Entries under the Size of Payment All Causes are arranged according to ranges (e.g., different rows correspond to payments from $1-$49, $50-$99, $100-$249, $250-$499, $500-$9,999, $10,000-$14,999, $15,000-$24,999, $25,000-$34,999-$35,000-$49,000, $50,000-$54,999, $55,000-$59,999, $60,000-$64,999, $65,000-$69,999, $70,000-$74,999, etc. in similar, five-thousand dollar ranges, which in this example embodiment continues up to $699,999 for Asthma COPD; ranges of course can differ for different diseases as will be understood by those having ordinary skill in the art, and ranges/limits can vary according to underlying data or disease).

The spreadsheet eliminates histogram bins from average claim amount data that are less than the claims amount paid multiplied by the claims lag factor. The average claim amount data (reflecting deleted histograms) is multiplied by a trend adjustment, which is 12% in the example. From this value, the claims amount paid is subtracted. To the resulting value, a prescription cost and disenrollee factor are applied.

With the benefit of this disclosure, those of ordinary skill in the art will recognize that the diagnoses listed in this example are representative only and that the techniques of this disclosure can be applied to any situation in which one wants to project costs, particularly costs for health care industry. Likewise, factor values can vary. Additionally, one or more factors can be removed while retaining use of one or more others.

With the benefit of the present disclosure, those having ordinary skill in the art will comprehend that techniques claimed herein and described above may be modified and applied to a number of additional, different applications, achieving the same or a similar result. For example, one will recognize that the steps of this disclosure can be used in different combinations and different orders, and some steps can be omitted and/or modified according to need to arrive at cost projections falling within the scope and spirit of this disclosure and particularly, the claims of this disclosure.

1. A method for projecting costs associated with a diagnosis, comprising:
identifying an average claim amount paid that is associated with the diagnosis using past claims data;
applying a trend adjustment to the average claim amount paid to yield an adjusted average claim amount paid;
identifying remaining costs by subtracting a value from the adjusted average claim amount paid; and
applying a prescription cost factor and disenrollee factor to the remaining costs to yield a cost projection associated with the diagnosis.

2. The method of claim 1, the value being subtracted from the adjusted average claim amount paid being claims that have already been paid.

3. The method of claim 1, the average claim amount paid being an average claim amount paid for all causes.

4. The method of claim 1, the average claim amount paid being an average claim amount paid for only the diagnosis.

5. The method of claim 1, the average claim amount paid being adjusted through the elimination of past claims data associated with claimants whose total incurred claims associated with a diagnosis are less than a particular value.

6. The method of claim 5, the particular value being the claims that have already been paid.

7. The method of claim 5, the particular value being the claims that have already been paid adjusted by a claim lag factor.

8. The method of claim 1, the diagnosis being selected from the group consisting of: Asthma; Chronic Obstructive Pulmonary Disease; Hemophilia; Premature Infants 500-749 grams; Tranplants; Cardiomyopathy; HIV/AIDS; Premature Infants 750-999 grams; Ulcerative Colitis; Cerebral Vascular Accident; Intervertebral Disc Disease; Premature Infants 1-1.25 kilograms; Average High Cost Case; Complications of Diabetes; Leukemia; Premature Infants 1.25-1.5 kilograms; Complications of Surgery; Liver Failure; Premature Infants 1.5-1.75 kilograms; Congenital Anomalies; Lymphoma; Premature Infants 1.75-2.0 kilograms; Congestive Heart Failure; Major Trauma; Premature Infants 2-2.5 kilograms; Coronary Artery Bypass; Malignant Neoplasms; Premature Infants>2.5 kilograms; Coronary Artery Disease; Morbid Obesity; Premature Infant Weight not otherwise specified; Electrolyte Disorders; Myocardial Infarction; Respiratory Failure; End Stage Renal Disease; Osteoarthritis; Sepsis; General Digestive Disorders; Premature Infants<500 grams; and Threatened/Premature Labor.

9. The method of claim 1, where the prescription cost factor and disenrollee factor comprise a single factor.

10. A method for projecting costs associated with a diagnosis, comprising:
identifying claims that have already been paid;
applying a claim lag factor to the claims that have already been paid to yield an adjusted paid claim value;
identifying an average claim amount paid that is associated with the diagnosis using past claims data, the average claim amount paid being adjusted through the elimination of past claims data associated with claimants whose total incurred claims associated with the diagnosis are less than the adjusted paid claim value;
applying a trend adjustment to the average claim amount paid to yield an adjusted average claim amount paid;
identifying remaining costs by subtracting the claims that have already been paid from the adjusted average claim amount paid; and
applying a prescription cost factor and disenrollee factor to the remaining costs to yield a cost projection associated with the diagnosis.

11. The method of claim 10, the diagnosis being selected from the group consisting of: Asthma; Chronic Obstructive Pulmonary Disease; Hemophilia; Premature Infants 500-749 grams; Tranplants; Cardiomyopathy; HIV/AIDS; Premature Infants 750-999 grams; Ulcerative Colitis; Cerebral Vascular Accident; Intervertebral Disc Disease; Premature Infants 1-1.25 kilograms; Average High Cost Case; Complications of Diabetes; Leukemia; Premature Infants 1.25-1.5 kilograms; Complications of Surgery; Liver Failure; Premature Infants 1.5-1.75 kilograms; Congenital Anomalies; Lymphoma; Premature Infants 1.75-2.0 kilograms; Congestive Heart Failure; Major Trauma; Premature Infants 2-2.5 kilograms; Coronary Artery Bypass; Malignant Neoplasms; Premature Infants>2.5 kilograms; Coronary Artery Disease; Morbid Obesity; Premature Infant Weight not otherwise specified; Electrolyte Disorders; Myocardial Infarction; Respiratory Failure; End Stage Renal Disease; Osteoarthritis; Sepsis; General Digestive Disorders; Premature Infants<500 grams; and Threatened/Premature Labor.

12. The method of claim 10, where the prescription cost factor and disenrollee factor comprise a single factor.

13. Computer readable media executable by a computer, the media comprising instructions for:
identifying an average claim amount paid that is associated with a diagnosis using past claims data;
applying a trend adjustment to the average claim amount paid to yield an adjusted average claim amount paid;
identifying remaining costs by subtracting a value from the adjusted average claim amount paid; and
applying a prescription cost factor and disenrollee factor to the remaining costs to yield a cost projection associated with the diagnosis.

14. The media of claim 13, the media comprising spreadsheet instructions.

15. The media of claim 13, the media further comprising instructions for:
identifying claims that have already been paid;
applying a claim lag factor to the claims that have already been paid to yield an adjusted paid claim value;
adjusting the average claim amount paid, prior to applying the trend adjustment, through the elimination of past claims data associated with claimants whose total incurred claims associated with the diagnosis are less than the adjusted paid claim value; and
wherein the value subtracted from the adjusted average claim amount paid is the claims that have already been paid.

16. The media of claim 13, where the prescription cost factor and disenrollee factor comprise a single factor.
